(19) United States
(12) Patent Application Publication
(10) Pub. No.: US 2008/0231191 A1
(43) Pub. Date: Sep. 25, 2008

(54) Electrode For a High Intensity Discharge Lamp

(75) Inventor: Pavel Pekarski, Aachen (DE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/913,704

(22) PCT Filed: May 8, 2006
(86) PCT No.: PCT/IB06/51434

§ 371 Date: Nov. 6, 2007

(30) Foreign Application Priority Data
May 11, 2005 (EP) 05103936.0

(51) Int. Cl. H01J 61/073; H01J 1/00; H01J 9/02

(52) U.S. Cl. 313/631; 313/356; 445/49

(57) ABSTRACT

The invention relates to an electrode for a high intensity discharge lamp, at least consisting of an electrode head (2), which has a spherical shape, and an electrode base (1), wherein, in the direction perpendicular to the longitudinal axis of the electrode, the electrode head (2) has a greater dimension than the electrode base (1) at the transition between electrode head (2) and electrode base (1), and a spherical electrode tip (3) is arranged on the electrode head (2), which electrode tip, in the direction perpendicular to the longitudinal axis of the electrode, has a smaller maximum dimension than the electrode head (2). A cylindrical protrusion (4) is arranged on the electrode tip (3), which cylindrical protrusion, in the direction perpendicular to the longitudinal axis of the electrode, has a smaller maximum dimension than the adjoining electrode tip (3). The electrode can be produced from a one-piece blank.

The invention relates to an electrode for a high intensity discharge lamp, at least consisting of an electrode head, which has a spherical shape, and an electrode base, wherein, in the direction perpendicular to the longitudinal axis of the electrode, the electrode head has a greater dimension than the electrode base at the transition between electrode head and electrode base, and a spherical electrode tip is arranged on the electrode head, which electrode tip, in the direction perpendicular to the longitudinal axis of the electrode, has a smaller maximum dimension than the electrode head.

High intensity discharge lamps (HID lamps) and in particular UHP (ultra high performance) lamps are preferably used inter alia for projection purposes on account of their optical properties. Within the context of the invention, the term UHP lamp (Philips) also encompasses UHP-type lamps made by other manufacturers.

High intensity discharge lamps usually have two electrodes, of which one forms the anode and/or one the cathode. These electrodes are often arranged opposite one another, on the longitudinal axis of the lamp, in a discharge chamber which is located in the lamp tube.

The electrodes each have an electrode head at their free end and the electrode base at their other end, said electrode base being permanently connected to the lamp. During operation of the lamp, a considerable amount of heat passes from the electrode to the lamp via this connection (heat bridge). By virtue of heat conduction, heat thus enters the region of the seal of the lamp tube, which serves to fix the electrode to the lamp. Undesirable recrystallization of the quartz material of this region cannot be ruled out, particularly in the seal or the so-called pinch.

The discharge chamber is hermetically sealed and is filled in particular with an inert gas, mercury and halogen in a known manner. Between the opposite parts of the electrodes, an arc discharge is created in the discharge chamber, wherein the arc serves as the light source of the high intensity discharge lamp.

Power is introduced through the internal electrodes, which are preferably made of tungsten. The electrodes are usually connected to an external ballast via molybdenum foils.

Electrodes for HID or UHP lamps with a spherical electrode head, which have a spherical electrode tip, are known for example from U.S. Pat. No. 6,552,499 B2. The spherical electrode head serves in particular as a heat buffer, in order to have an influence on the transfer of heat from the electrode tip into the electrode base.

In the described electrode, as a result of the melting of the material of the electrode head on account of the hot arc which forms, the electrode tip automatically forms at the free end of the electrode head during the first hours of operation of the lamp.

This process can be described for example as follows:

As the arc forms, atoms of the electrode material evaporate and are ionized in the plasma. These tungsten ions deposit on the surface of the electrode under the effect of the electric field and form agglomerations of material. Such agglomerations of material have a size of for example between 100 and 500 μm and are unstable in terms of their position and size, as a result of which the position of the arc is affected. This may lead to undesirable positional shifts, i.e. positions of the arc which change over time. This is true particularly in the case where such migration of the agglomerations of material on the surface of the electrode leads to significant positional shifts relative to the plane which is approximately perpendicular to the axis of the lamp. If the surface there is suitably large, it is even possible for a number of such agglomerations of material to form, and this usually additionally leads to considerable instabilities of the arc. This causes fluctuations in light intensity, which are highly disruptive in particular during operation of UHP lamps for projection purposes.

WO 03/001563 A1 discloses electrodes for HID and UIP lamps with a spherical electrode head, which have a conical electrode tip at the free end of the electrode head. These conical electrode tips are said to limit the ability of the agglomerations of material which form to migrate on the surface of the conical tip. The conical shape is intended to prevent agglomerations of material from forming on the surface of the spherical electrode head and migrating thereon.

These electrodes with a conical tip are produced in a technologically complex manner by joining two parts together. This requires very precise positioning and holding of the two parts while these two very small parts are joined together.

The first part of the subsequent electrode is produced with the electrode base and the spherical electrode head by locally melting and then cooling a one-piece cylindrical blank. This first part is then joined to a cylindrical second part, with the conical part of the electrode tip being formed in the process or thereafter. In a further method step, the remaining part of the cylindrical second part is separated from the electrode.

Moreover, this solution limits the design possibilities of the lamp, since the diameter of the spherical electrode head is usually limited by the diameter of the inner lamp tube; this diameter is typically approx. 2 mm.

Electrode heads which, in the direction perpendicular to the longitudinal axis of the electrode, have a greater dimension than the adjoining electrode base of the electrode, particularly the dimension thereof at the transition between the electrode head and the electrode base, are used in particular as heat buffers and heat radiators to reduce the transfer of heat from the electrode head into the lamp via the electrode base.

These electrode heads are usually ball-shaped or spherical, but are not limited to these shapes within the context of the invention.

One disadvantage with these electrode heads is that, particularly above a certain size or dimension in the direction perpendicular to the longitudinal axis of the electrode, one or more electrode tips form automatically on the electrode head during operation of the lamp, and these electrode tips are not stable.

In the case of two electrodes which are arranged opposite one another on an axis, particularly the longitudinal axis of the lamp, the dimension in the direction perpendicular to the longitudinal axis is of particular importance.

This is because the mechanically unstable electrode tips (agglomerations of material) are also unstable with regard to their respective position, that is to say they can be found at different locations perpendicular to the lamp axis at different points in time. The service life of the lamp is adversely affected by this “migration” of these unstable electrode tips.

It is an object of the invention to provide an electrode for high intensity discharge lamps of the type mentioned above and a corresponding high intensity discharge lamp with an improved service life, in order to reduce the undesirable “migration” of an unstable electrode tip (agglomeration of material) and thus improve the stability of the arc of the high intensity discharge lamp. The design of the electrode should allow simple and cost-effective production of the electrode. Moreover, methods are to be provided which allow industrial mass production of such electrodes in an efficient and cost-effective manner.

The object of the invention is achieved by the features of claim 1.

It is essential to the invention that a cylindrical protrusion is arranged on the electrode tip, which cylindrical protrusion, in the direction perpendicular to the longitudinal axis of the electrode, has a smaller maximum dimension than the adjoining electrode tip, and the electrode can be produced from a one-piece blank.

By virtue of the solution according to the invention, the region of the electrode which is melted by the arc during operation of the lamp, even with a large electrode head, i.e. in particular the maximum dimension of the electrode head is greater than 400 μm, is dimensioned in such a way that this does not lead to any reduction in service life. Without functional impairment, it is possible to optimize the minimum dimension, in the direction perpendicular to the lamp axis, of the region of the electrode which is melted by the arc.

Moreover, further design possibilities in respect of electrodes and thus also the lamp tube geometry are opened up as a result of the presence of at least two regions of the electrode, namely the electrode tip and the electrode head, wherein each of these has heat buffering functions.

By way of example, as a result of the presence of the electrode tip, the diameter of the electrode head can be reduced while having a comparable ability for heat buffering overall.

The electrode head, the electrode tip and the protrusion and—where present—the buffer element are made of the conventional electrode materials and are in particular designed to be solid.

The electrode head, the electrode tip and—where present—the buffer element are shaped in a spherical manner, wherein this shape is formed automatically in an extremely simple manner as a result of the action of surface stresses during cooling of the molten electrode material.

Within the context of the invention, the term “spherical” relates to differences in the outer contour, that is to say differing from a ball shape, but also to the fact that often only segments of a complete ball shape are actually used.

The parts of the electrode, such as the electrode head and the electrode base, electrode head and electrode tip or electrode tip and protrusion, can be produced by methods known per se.

Use may also be made here for example of known methods of welding and laser technology.

It is preferred that arranged between the electrode head and the electrode base is at least one buffer element which has a spherical shape and, in the direction perpendicular to the longitudinal axis of the electrode, has a smaller maximum dimension than the electrode head and a greater maximum dimension than the electrode base. Further design possibilities in respect of the electrode and lamp geometry are thus opened up.

By virtue of a further embodiment of the invention, it is preferred that the diameter of the electrode tip has a value of between 1700 μm and 300 μm.

It is moreover preferred that the protrusion has a maximum axial dimension of 200 to 1500 μm and a diameter of 200 μm to 1000 μm, particularly preferably between 300 μm and 600 μm.

The object of the invention is furthermore achieved by a method of producing an electrode as claimed in claim 1.

It is additionally preferred that the electrode head is produced by locally melting and then cooling a one-piece cylindrical blank.

The object of the invention is furthermore achieved by an HIP lamp comprising at least one electrode as claimed in claim 1.

The invention will be further described with reference to examples of embodiments shown in the drawings to which, however, the invention is not restricted.

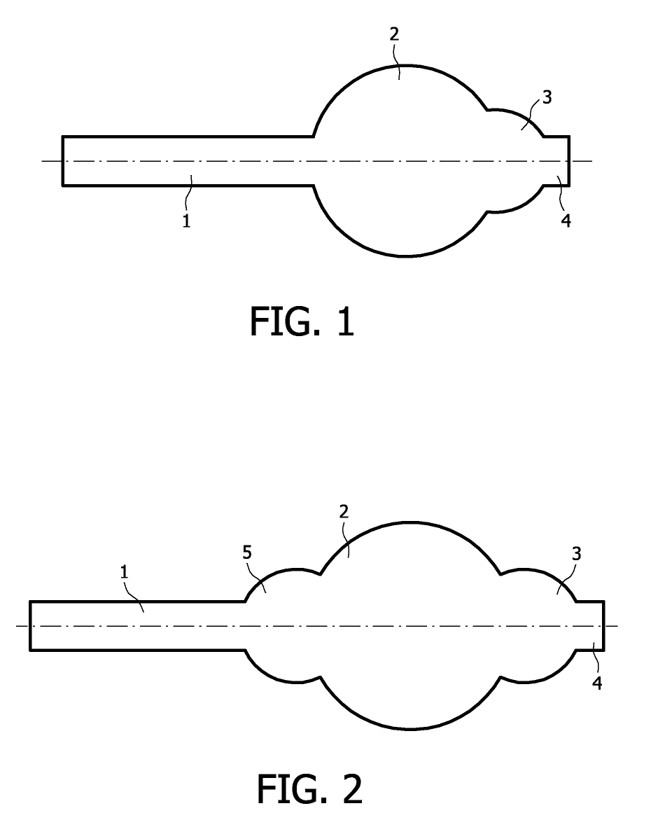

FIG. 1 shows a schematic sectional diagram of an electrode according to the invention.

FIG. 2 shows a schematic sectional diagram of a further embodiment of an electrode according to the invention with a buffer element.

FIG. 1 shows a schematic sectional diagram of an electrode according to the invention, wherein the longitudinal axis of the electrode is the axis of symmetry, shown as a dashed line. The electrode for a high intensity discharge lamp, namely a UHP lamp with a power consumption of 130 W, comprises an electrode head 2 and an electrode base 1. The electrode head 2 has, in the direction perpendicular to the longitudinal axis of the electrode, a greater maximum dimension than the electrode base 1 at the transition to the electrode head 2. The diameter, that is to say the maximum dimension, of the spherical, rotationally symmetrical electrode head 2 is 1.4 mm; the diameter of the cylindrical electrode base 1 at the transition to the electrode head is 0.4 mm. Adjoining the electrode head 2 is a spherical, symmetrical electrode tip 3, the maximum dimension of which, in the direction perpendicular to the longitudinal axis of the electrode, is 0.7 mm, and is thus smaller than the diameter of the electrode head 2.

Adjoining the electrode tip 3, toward the free end of the electrode, is a cylindrical, rotationally symmetrical protrusion 4. This protrusion 4 has a diameter of 0.4 mm and is thus smaller than the maximum dimension of the electrode tip 3, in the direction perpendicular to the longitudinal axis of the electrode. The protrusion 4 has an axial dimension of 300 μm.

The electrode, which is made of tungsten, is produced from a cylindrical rod which is simultaneously heated and melted at the appropriate point of the rod by means of known methods of welding or laser technology, for example by means of a number of lasers, wherein said rod rotates about its axis of symmetry. After cooling, a spherical structure is obtained, this being the subsequent electrode head. Thereafter, part of the spherical structure is heated and cooled in a comparable manner, so that then the electrode head 2 and the electrode tip 3 are shaped in the illustrated spherical manner.

Prior to first operation of the lamp, the shape of the protrusion 4 corresponds to the shape of the original rod, that is to say is cylindrical.

After about a few hundred hours of operation, the shape of the protrusion 4 has changed; the surface has been at least partially removed and exhibits an agglomeration of material.

FIG. 2 shows a schematic sectional diagram of an electrode according to the invention with a buffer element 5.

Unlike in FIG. 1, the electrode additionally has a buffer element 5 which is arranged between the electrode head 2 and the electrode base 1. The buffer element 5, which has a spherical shape, has a smaller maximum diameter (0.8 mm) than the electrode head 2 (1.4 mm) and a greater maximum diameter than the electrode base 1 (0.4 mm).

The following rule has been taken into account here for the dimensioning of the electrode head:

1.5×d(4)<d(3)<2.5×d(4)

Herein:

d(3) is the maximum diameter of the electrode tip 3 and

d(4) is the maximum diameter of the protrusion 4.

This dimensioning rule ensures that there is such a small radial dimension of the electrode tip 3 that it is possible only for an agglomeration of material to form which allows only insignificant positional shifts in the radial direction. The desired buffer action of the electrode tip 3, particularly during the so-called run-up phase, is not adversely affected.

The following rule has been taken into account here for the dimensioning of the electrode tip 3 (the same applies in respect of the buffer element 5):

d(3)<d(2), in particular 1.5×d(3)<d(2) and

1.2×d(4)<d(2-3), in particular 1.5×d(4)<d(2-3).

Herein:

d(2) is the maximum diameter of the electrode head 2

d(3) is the maximum diameter of the electrode tip 3

d(4) is the maximum diameter of the protrusion 4, and

d(2-3) is the maximum radial dimension at the transition from the electrode tip 3 to the electrode head 2.

1. An electrode for a high intensity discharge lamp, at least consisting of an electrode head (2), which has a spherical shape, and an electrode base (1), wherein, in the direction perpendicular to the longitudinal axis of the electrode, the electrode head (2) has a greater dimension than the electrode base (1) at the transition between electrode head (2) and electrode base (1), and a spherical electrode tip (3) is arranged on the electrode head (2), which electrode tip, in the direction perpendicular to the longitudinal axis of the electrode, has a smaller maximum dimension than the electrode head (2), characterized in that a cylindrical protrusion (4) is arranged on the electrode tip (3), which cylindrical protrusion, in the direction perpendicular to the longitudinal axis of the electrode, has a smaller maximum dimension than the adjoining electrode tip (3), and the electrode can be produced from a one-piece blank.

2. An electrode as claimed in claim 1, characterized in that arranged between the electrode head (2) and the electrode base (1) is at least one buffer element (5) which has a spherical shape and, in the direction perpendicular to the longitudinal axis of the electrode, has a smaller maximum dimension than the electrode head (2) and a greater maximum dimension than the electrode base (1).

3. An electrode as claimed in claim 1, characterized in that the electrode head (2) has a greatest dimension of between 700 and 3000 μm.

4. An electrode as claimed in claim 1, characterized in that the diameter of the electrode tip (3) has a value of between 1700 μm and 300 μm.

5. An electrode as claimed in claim 1, characterized in that the protrusion (4) is shaped in a rotationally symmetrical manner and has a cylindrical shape.

6. An electrode as claimed in claim 5, characterized in that
the protrusion (4) has an axial dimension of at most 200 to 1500 μm, particularly preferably between 200 μm and 800 μm, and
a diameter of 200 μm to 1000 μm.

7. A method of producing an electrode as claimed in claim 1, wherein the protrusion (4) is shaped in a rotationally symmetrical manner and has a cylindrical shape, and the electrode can be produced from a one-piece blank.

8. A method as claimed in claim 7, characterized in that the electrode head (2) is produced by locally melting and then cooling a one-piece cylindrical blank.

9. A method as claimed in claim 8, characterized in that the method step of producing the electrode head (2) is followed by the production of the electrode tip (3) and/or of the electrode tip (3) and buffer element (5) by locally melting and then cooling the one-piece electrode material.

10. A method as claimed in claim 8, characterized in that the local melting of the one-piece cylindrical blank is carried out by means of a laser melting process.

11. An HID lamp comprising at least one electrode as claimed in claim 1.
